(19) United States
(12) Patent Application Publication
(10) Pub. No.: US 2019/0329387 A1
(43) Pub. Date: Oct. 31, 2019

(54) CONNECTION DEVICE FOR CONNECTING AND RELEASING A SOCKET RELATIVE TO A RATCHET WRENCH

(71) Applicant: Yi-Fu Chen, Taichung City (TW)

(72) Inventor: Yi-Fu Chen, Taichung City (TW)

(21) Appl. No.: 15/965,984

(22) Filed: Apr. 30, 2018

(51) Int. Cl. B25B 23/00; B25B 13/46

(52) U.S. Cl. CPC B25B 23/0035; B25B 23/0028; B25B 13/462

(57) ABSTRACT

A connection device of a ratchet wrench includes a connection portion extending from the head of a ratchet wrench and having a receiving hole. A tool part includes a ball head and a driving portion which is connected to the ball head by a neck. The ball head includes multiple curved faces, and a ridge is formed between any two adjacent curved faces. A clutch device is mounted to the connection portion to secure or release the ball head of the tool part relative to the receiving hole of the connection portion. The ball head of the tool part allows the tool part to be tilt relative to the head of the wrench.

### BACKGROUND OF THE INVENTION

### 1. Fields of the Invention

The present invention relates to a ratchet wrench, and more particularly, to a connection device for quickly connecting or releasing a tool part relative to a ratchet wrench.

### 2. Descriptions of Related Art

The conventional ratchet wrenches include a head with a ratchet mechanism received in therein, and a ratchet wheel is rotatably received in the head so as to output torque in desired direction by operation of a switch device on the wrench. Some ratchet wrenches for being connected with a socket includes a rectangular protrusion from the head so as to be connected with a socket which is perpendicularly connected to the head of the wrench. However, the angle of the socket relative to the head of the wrench cannot be adjusted so that the conventional socket and wrench cannot conveniently access the object to be tightened or loosened in a narrow space. Although some wrenches is connected with a socket that has a hall head, and the socket can be adjusted, a new problem is that the connection between the connection between the ball head of the socket and the wrench is not stable so that cannot output a stable and high torque.

The present invention intends to provide a connection device of a ratchet wrench and the connection device that is designed to eliminate the drawbacks mentioned above.

### SUMMARY OF THE INVENTION

The present invention relates to a connection device of a ratchet wrench, and comprises a connection portion extending from one end of the head of a ratchet wrench. The connection portion has a receiving hole defined axially therein which is a polygonal hole. A tool part has a ball head and a driving portion which is connected to the ball head by a neck. The ball head includes multiple curved faces. The curved faces each are a recessed faces with an identical curvature, and the curved faces are located around the axis of the driving portion. A ridge is formed between any two adjacent curved faces. A clutch device is connected to the connection portion to secure or release the ball head of the tool part relative to the receiving hole of the connection portion.

Preferably, the clutch device includes a first hole defined through the wall of the connection portion. A C-shaped expandable ring is mounted to outside of the connection portion and has an opening formed between two ends of the C-shaped expandable ring. A second hole is defined through the wall of the expandable ring and located in alignment with the first hole. A ball is movably engaged with the first and second holes. The C-shaped expandable ring pushes the ball toward the receiving hole so that a portion of the ball protrudes into the receiving hole and is engaged with the neck of the tool part to maintain the ball bead within the receiving hole of the connection portion. When a portion of the ball head that has a maximum diameter contacts and pushes the ball, the ball is pushed away from the receiving hole and the expandable ring is expanded, so that the ball head is releasable from the receiving hole of the connection portion.

Preferably, the clutch device includes a first hole defined through the wall of the connection portion and a ball is movably engaged with the first hole. A control ring is mounted to outside of the connection portion. A spring is biased between an end face of the bead and an end of the control ring. The control ring includes a maximum diameter portion and a minimum diameter portion formed in the inner periphery thereof. When the minimum diameter portion of the control ring is located corresponding to the ball, the ball is pushed to protrude into the receiving hole and engaged with the neck of the tool part to maintain the ball bead within the receiving hole of the connection portion. When moving the control ring to compress the spring, the maximum diameter portion of the control ring is located corresponding to the ball, when a portion of the ball head that has a maximum diameter contacts and pushes the ball, the ball is pushed away from the receiving hole so that the ball is received in the maximum diameter portion of the control ring, the ball head is releasable from the receiving hole of the connection portion.

Preferably, the driving portion of the tool part is a socket with a polygonal recess.

Preferably, the driving portion of the tool part is a polygonal rod.

Preferably, the ball head includes six curved faces and six ridges.

The advantages of the present invention are that the ball head of the tool part can be vertical or tilt an angle relative to the head of the wrench.

The ball head of the tool part is adjusted according to needs so as to easily access the objects to be tightened or loosened.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the connection device of the present invention;

FIG. 2 is a cross sectional view of the first embodiment of the connection device of the present invention, wherein the ball head of the tool part is engaged with the receiving hole and the ball is engaged with the neck of the tool part;

FIG. 3 is a cross sectional view of the first embodiment of the connection device of the present invention, wherein the ball head of the tool part is moved downward to push the ball away from the receiving hole;

FIG. 4 shows that the tool part is engaged with an object head;

FIG. 5 shows the second embodiment of connection device of the present invention;

FIG. 6 is an exploded view of the third embodiment of the connection device of the present invention;

FIG. 7 is a cross sectional view of the third embodiment of the connection device of the present invention, wherein the ball head of the tool part is engaged with the receiving hole and the balls are engaged with the neck of the tool part, and

FIG. 8 is a cross sectional view of the third embodiment of the connection device of the present invention, wherein the ball head of the tool part is pulled downward and the balls are pushed away from the receiving hole.

### DETAILED DESCRIPTION OF THE PREFERRED EMBODIMENT

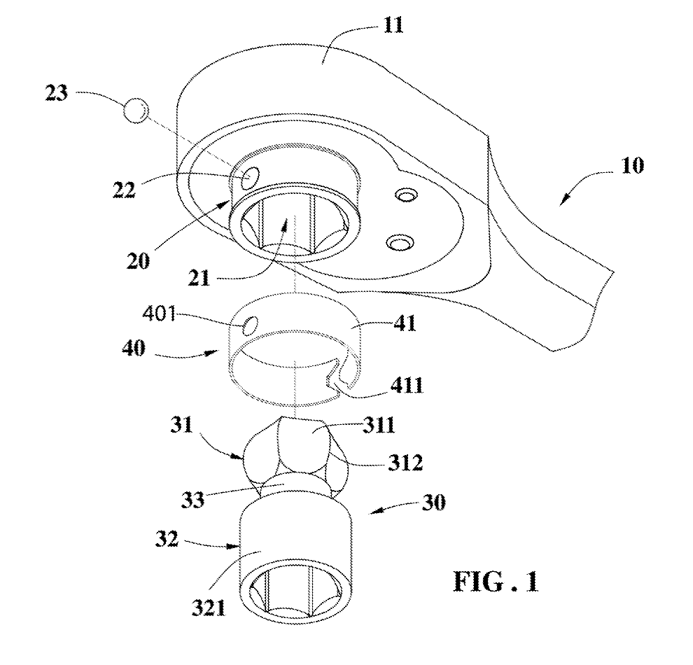

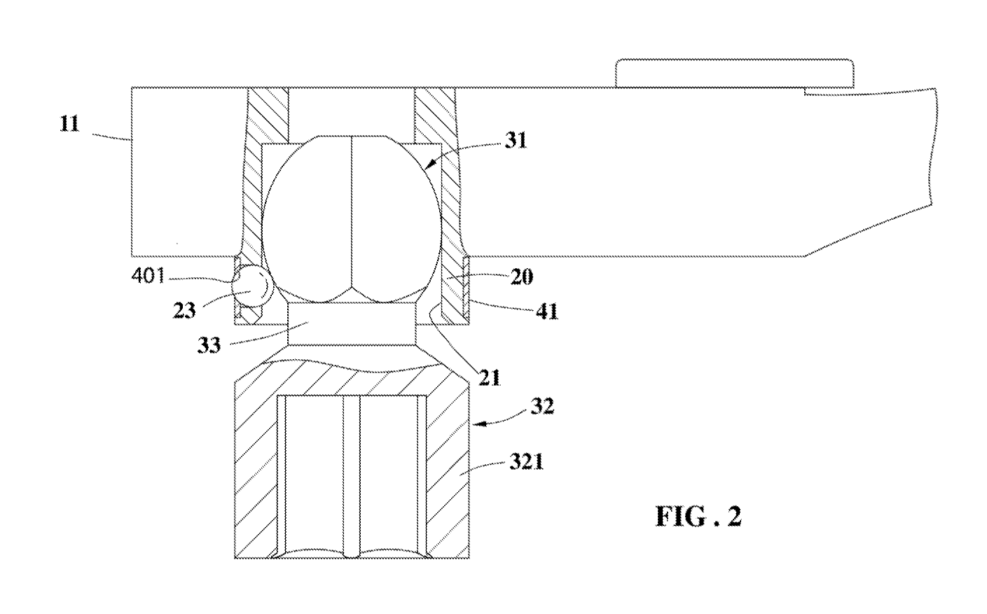

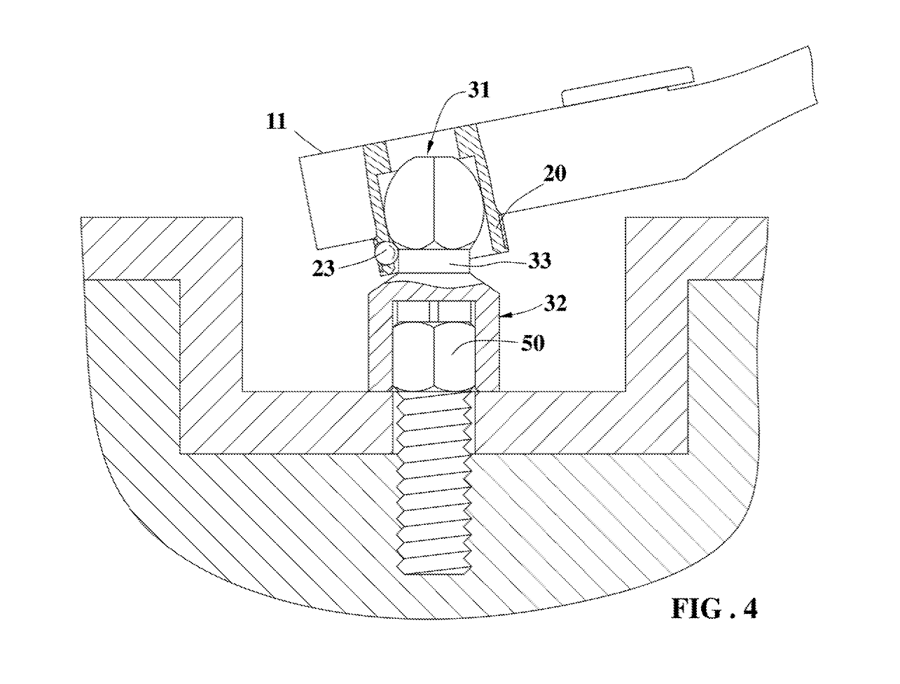

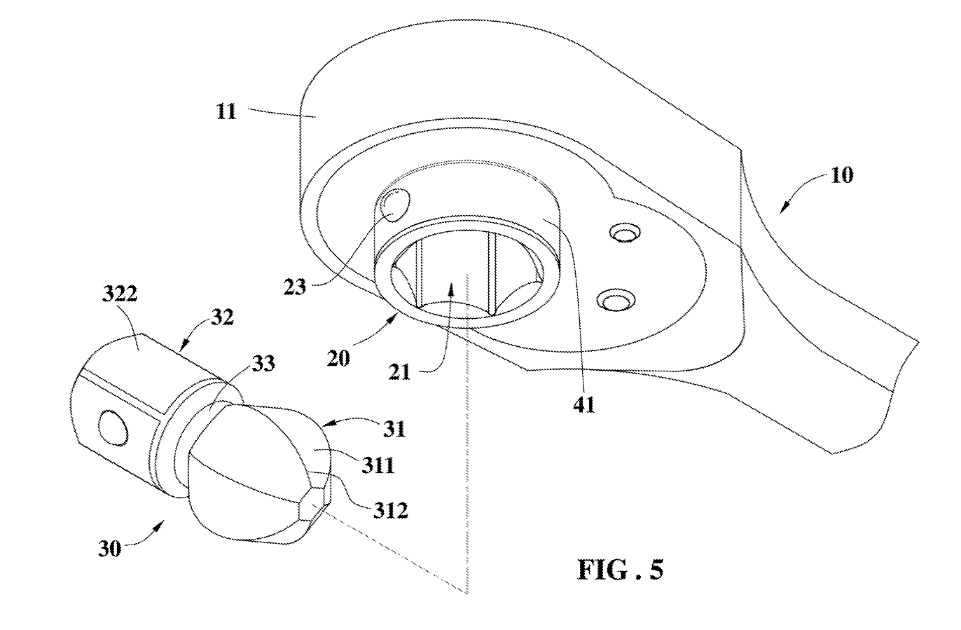

Referring to FIGS. 1 to 2, the connection device of a ratchet wrench of the present invention comprises a connection portion 20 extending from one end of a head 11 of a ratchet wrench 10, wherein the connection portion 20 is an annular part and has a polygonal receiving hole 21 defined axially therein. A tool part 30 includes a ball head 31 and a driving portion 32 which is connected to the ball head 31 by a neck 33 which has a smaller diameter than that of the ball head 31 and the driving portion 32. The ball head 31 includes multiple curved faces 311, and the curved faces 311 each are a recessed faces with an identical curvature. The curved faces 311 are located around the axis of the driving portion 32, and a ridge 312 is formed between any two adjacent curved faces 311. The driving portion 32 of the tool part 30 can be a socket 3211 with a polygonal recess as shown in FIG. 4, or a polygonal rod 322. As shown in FIG. 5. The ball head 31 includes may have six curved faces 311 and six ridges 312, and other shape of the ball head 31 can also be available.

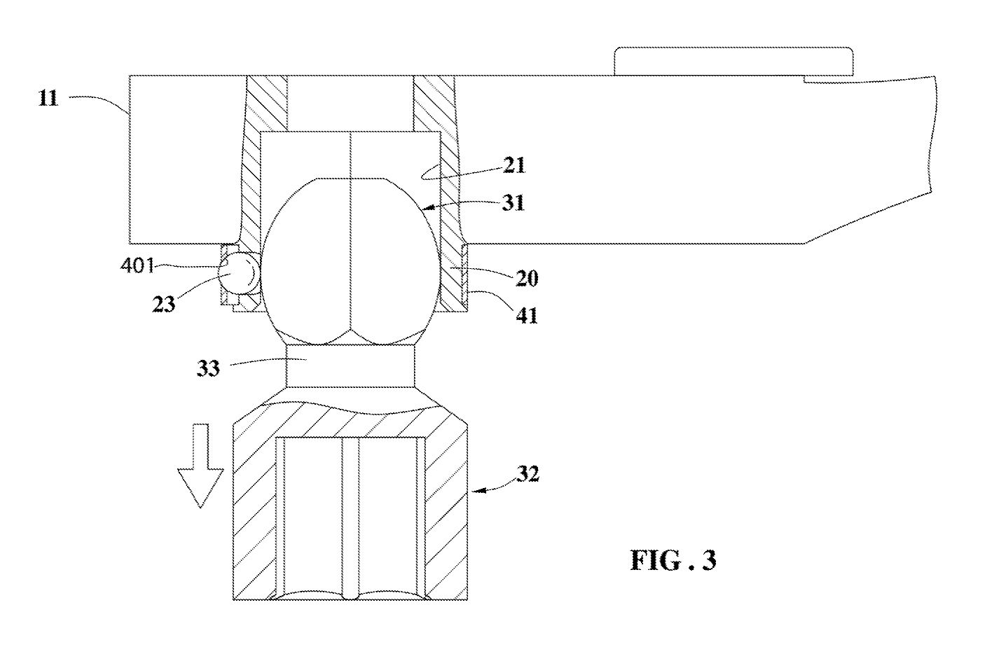

A clutch device 40 is connected to the connection portion 20 to secure or release the ball head 31 of the tool part 30 relative to the receiving hole 21 of the connection portion 20. The clutch device 40 includes a first hole 22 defined through the wall of the connection portion 20. A C-shaped expandable ring 41 is mounted to outside of the connection portion 20 and has an opening 411 formed between two ends of the C-shaped expandable ring 41. In other words, the opening 411 allows the expandable ring 41 to expandable. A second hole 410 is defined through the wall of the expandable ring 41 and located in alignment with the first hole 22. A ball 23 is movably engaged with the first and second holes 22, 410. When the tool part 30 is connected to the connection portion 20 as shown In FIG. 2, the inside of the C-shaped expandable ring 41 pushes the ball 23 toward the receiving hole 21 so that a portion of the ball 23 protrudes into the receiving hole 21 and is engaged with the neck 33 of the tool part 30 to maintain the ball bead 21 within the receiving hole 21 of the connection portion 20. As shown in FIG. 3, when pulling the tool part 30 away from the connection portion 20, a portion of the ball head 31 that has a maximum diameter contacts and pushes the ball 23, the ball 23 is pushed away from the receiving hole 21 and the expandable ring 41 is expanded, so that the ball head. 31 is released from the receiving hole 21 of the connection portion 20. Similarly, when connecting the tool part 30 to the receiving hole 21 of the connection portion 20, simply inserting the ball head 31 through the expandable ring 41 to push the ball 23 and the tool part 30 is retained in the receiving hole 21 when the ball 23 is engaged with the neck 33.

As shown in FIG. 4, the ball head 31 allows the head 11 of the ratchet wrench 10 to be pivoted about the ball head 31 so that the tool part 30 is tilt relative to the ratchet wrench 10. Therefore, the tool part 30 can access the object head 50 in a narrow space. The ball head. 31 of the tool part 30 can be vertical or tilt an angle relative to the head 11 of the ratchet wrench 10 as respectively shown in FIGS. 2 and 4.

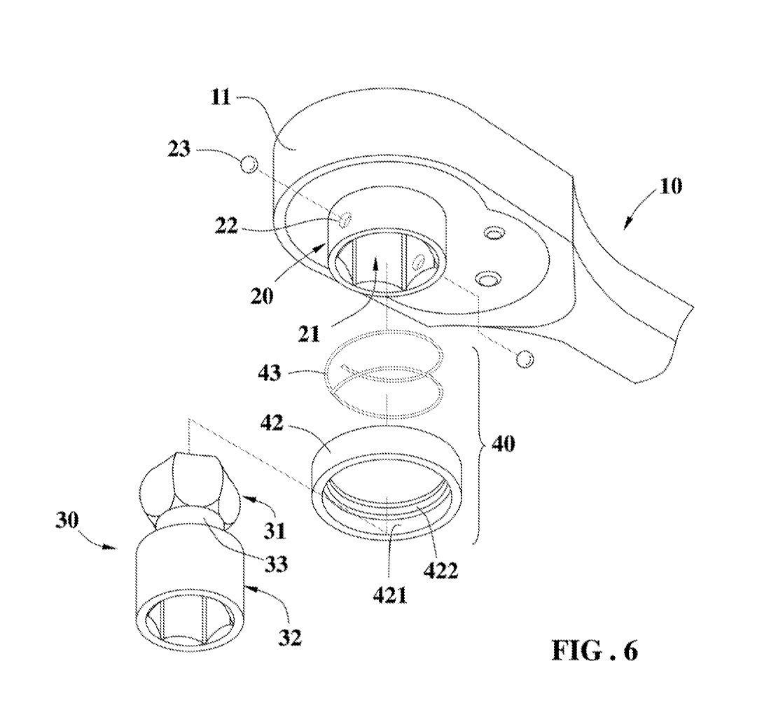

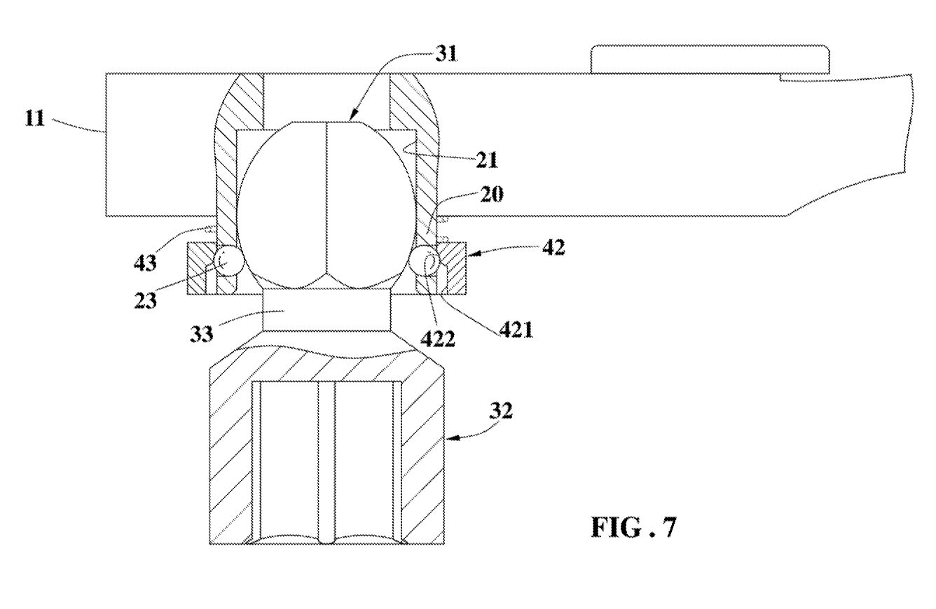

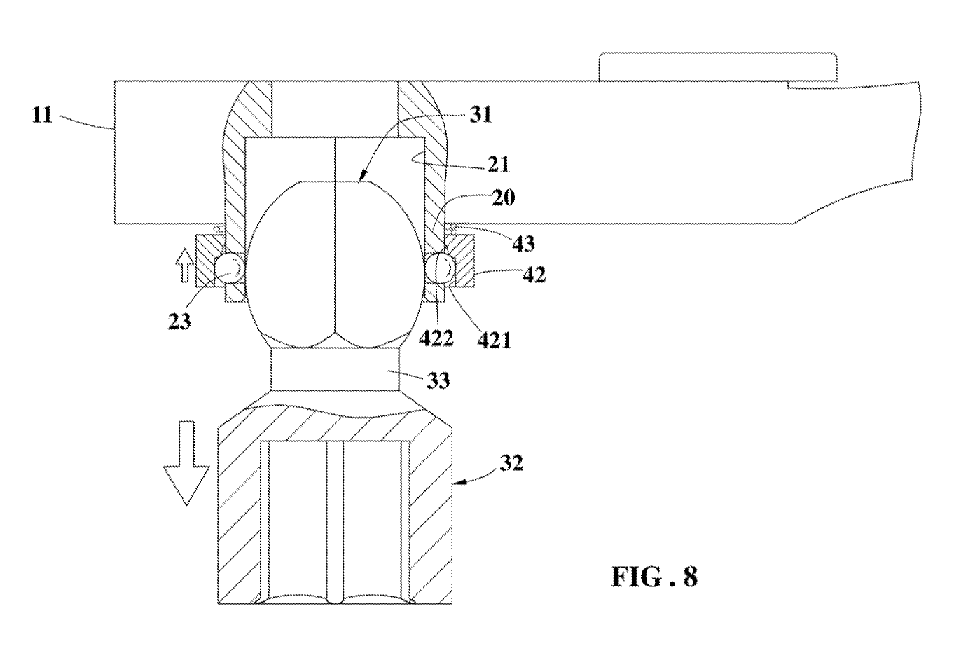

As shown in FIGS. 6 to 8, the clutch device 40 may include a first hole 22 defined through the wall of the connection portion 20 and a hall 23 is movably engaged with the first hole 22. A control ring 42 is mounted to outside of the connection portion 20. A spring 43 is biased between an end face of the head 11 and an end of the control ring 42. The control ring 42 includes a maximum diameter portion 421 and a minimum diameter portion 422 formed in the inner periphery thereof. When the minimum diameter portion 422 of the control ring 42 is located corresponding to the ball 23, the ball 23 is pushed to protrude into the receiving hole 21 and engaged with the neck 33 of the tool part 30 to maintain the ball bead. 31 within the receiving hole 21 of the connection portion 20. When moving the control ring 42 to compress the spring 43, the maximum diameter portion 421 of the control ring 42 is located corresponding to the ball 23, and the ball 23 is no longer pushes by the minimum diameter portion 422 of the control ring 42. When a portion of the ball head 31 that has a maximum diameter contacts and pushes the ball 23, the ball 23 is pushed away from the receiving hole 21 and the tool part 30 can be disconnected from the ratchet wrench 10. The tool part 50 can be connected to the ratchet wrench 10 again simply inserting the ball head 31 into the control ring 42 and the connection portion 20.

While we have shown and described the embodiment in accordance with the present invention, it should be clear to those skilled in the art that further embodiments may be made without departing from the scope of the present invention.

What is claimed is:

1. A connection device of a ratchet wrench, comprising:
a connection portion extending from an end of a head of a ratchet wrench, the connection portion having a receiving hole defined axially therein which is a polygonal hole;
a tool part having a ball bead and a driving portion which is connected to the ball head by a neck, the ball head including multiple curved faces, the curved faces each being a recessed faces with an identical curvature, the curved faces located around an axis of the driving portion, a ridge formed between any two adjacent curved faces, and
a clutch device connected to the connection portion to secure or release the ball head of the tool part relative to the receiving hole of the connection portion.

2. The connection device of a ratchet wrench as claimed in claim 1, wherein the clutch device includes a first hole defined through a wall of the connection portion, a C-shaped expandable ring is mounted to outside of the connection portion and has an opening formed between two ends of the C-shaped expandable ring, a second hole is defined through a wall of the expandable ring and located in alignment with the first hole, a ball is movably engaged with the first and second holes, the C-shaped expandable ring pushes the ball toward the receiving hole so that a portion of the ball protrudes into the receiving hole and is engaged with the neck of the tool part to maintain the ball bead within the receiving hole of the connection portion, when a portion of the ball head that has a maximum diameter contacts and pushes the ball, the ball is pushed away from the receiving hole and the expandable ring is expanded, the ball head is releasable from the receiving hole of the connection portion.

3. The connection device of a ratchet wrench as claimed in claim 1, wherein the clutch device includes a first hole defined through a wall of the connection portion and a ball is movably engaged with the first hole, a control ring is mounted to outside of the connection portion, a spring is biased between an end face of the head and an end of the control ring, the control ring includes a maximum diameter portion and a minimum diameter portion formed in an inner periphery thereof, when the minimum diameter portion of the control ring is located corresponding to the ball, the ball is pushed to protrude into the receiving hole and engaged with the neck of the tool part to maintain the ball bead within the receiving hole of the connection portion, when moving the control ring to compress the spring, the maximum diameter portion of the control ring is located corresponding to the ball, when a portion of the ball head that has a maximum diameter contacts and pushes the ball, the ball is pushed away from the receiving hole so that the ball is received in the maximum diameter portion of the control ring, the ball head is releasable from the receiving hole of the connection portion.

4. The connection device of a ratchet wrench as claimed in claim 1, wherein the driving portion of the tool part is a socket with a polygonal recess.

5. The connection device of a ratchet wrench as claimed in claim 1, wherein the driving portion of the tool part is a polygonal rod.

6. The connection device of a ratchet wrench as claimed in claim 1, wherein the ball head includes six curved faces and six ridges.
